(19) United States
(12) Patent Application Publication
(10) Pub. No.: US 2019/0232450 A1
(43) Pub. Date: Aug. 1, 2019

(54) DRIVE UNIT

(71) Applicant: WEISS GmbH, Buchen (DE)

(72) Inventor: Arnold Horn, Hardheim-Erfeld (DE)

(21) Appl. No.: 16/306,343

(22) PCT Filed: Oct. 5, 2017
(86) PCT No.: PCT/EP2017/075345

§ 371 Date: Nov. 30, 2018

(30) Foreign Application Priority Data
Oct. 7, 2016 (DE) 10 2016 119 076.4

(51) Int. Cl. B23Q 15/013; B23Q 16/02

(52) U.S. Cl. CPC B23Q 15/013; B23Q 2220/004; B23Q 16/025

(57) ABSTRACT

A drive unit having a transport element has at least one entrainer engaging into a drive groove of a barrel cam, an electrical drive device, and a base control device that is adapted to receive control signals for the operation of the drive unit from a user interface programmable by an operator and to output a drive signal to the drive device in dependence on a received control signal. The drive device is adapted to drive the barrel cam to make a rotational movement and thus to drive the transport element in response to the drive signal. The base control device is further adapted to selectively operate the drive device in a full operation mode or, if no control signal is received after the output of a drive signal and after the elapse of a cycle time duration of the drive unit, to set it into a standby operation mode in which an electrical supply of the drive device is interrupted.

The present invention relates to a drive unit having a transport element that has at least one entrainer engaging into a drive groove of a barrel cam, having an electrical drive device, and having a base control device. The drive unit forming the category can be configured, for example, as a so-called rotary indexing table, wherein the transport element can be a turntable and the drive device can be an electric motor—directly or indirectly—coupled to the barrel cam. The turntable on which, for example, objects to be processed by machining are located can in this manner be rotated between desired machining positions by the electric motor.

The base control device is adapted to receive control signals for the operation of the drive unit from a user interface programmable by the operator and to output a drive signal to the drive device in dependence on a received control signal. The drive device is adapted to drive the barrel cam to make a rotational movement and thus to drive the transport element in response to the drive signal. The base control device ultimately controls the current feed of the motor according to requirements.

The base control device acts as an intermediary between the received control signals and the drive signals which are tailored to the specific drive device and by which the control signals intended for the drive device are implemented. An advantage of this solution can be found—presupposing a corresponding configuration of the base control device—in that the drive unit can be easily integrated into a higher level control (e.g. of a factory), with this control not having to be familiar with the specific control modalities for the drive device. Descriptive instructions such as “Rotate turntable by 90°” can instead be transmitted in the form of a respective control signal to the base control device that thereupon determines the required drive signal and transmits it to the drive device or controls the required current feed of the motor.

It is disadvantageous with known drive units that the drive device always has to be fully ready for operation to be able to directly implement a received control signal. An efficient and safe operation of the drive unit is hereby prevented since the drive device is only required at times as a rule.

It is an object of the invention to provide a drive unit of the initially named kind that can be operated more efficiently and more safely. The energy consumption should in particular be lowered and the service life of the drive unit can be improved. A further object of the invention is a corresponding method of operating the drive unit.

The object is satisfied by a drive unit having the features of claim 1 and by a method having the features of claim 9.

The base control device of the drive unit in accordance with the invention is adapted to selectively operate the drive device in a full operation mode or, if no control signal is received after the output of a drive signal and after the elapse of a cycle time duration of the drive unit, to set it into a standby operation mode in which an electrical supply of the drive device is interrupted.

It has been recognized in accordance with the invention that the drive unit of the prior art is basically a passive instruction receiver and instruction executor. information on the higher level operating routine are kept concealed from it so that to this extent no targeted or smart operation of the drive unit can be achieved. The operation of the drive unit of the prior art is therefore not always particularly efficient or safe. This would, however, nevertheless be possible if specific information of the operating routine were determined and used to make the mode of operation of the drive unit more efficient. It was recognized that the knowledge of a regularly recurring pattern of the operating routine can be used to lower the power consumption of the drive unit, in particular in the case of an interruption of the operating routine.

A recurring pattern of the operating routine can generally be described by a regular sequence of one or more different control signals. The duration between two consecutive control signals is here generally called the cycle time duration of the drive unit. The consecutive control signals can be two directly consecutive control signals intended for the drive device or two control signal intended for the drive device between which, however, other control signals could lie viewed from a time aspect. The term cycle” e.g. relates to a cycle of the drive unit.

The invention makes use of the recognition that the drive device works cyclically in the normal operating procedure i.e. in intervals of the cycle time duration a control signal (i.e. movement of the transport element, in particular rotation of the turntable by a specific angle) is required for the implementation. If the cycle time duration is exceeded, an interruption of the normal operating procedure is present and the drive device is set into a standby operation mode in which an electrical supply of the drive device is interrupted. The drive device can e.g. be completely or partly cut off from a mains voltage supply and can thus ultimately be deactivated. An electric power component of the drive device can in particular be cut off from the electrical supply in the standby operation mode. A current feed of an electric motor of the drive device can then be interrupted, for instance.

The interruption of the electrical supply, on the one hand, reduces the electric power consumption or even suppresses it completely. This also brings about a smaller heating of the drive device and thus of the drive unit in addition to a reduced energy consumption. The efficiency and service life of the drive unit are thus considerably improved. On the other hand, the interruption of the electrical supply also provides a safer operation of the drive unit or drive device since e.g. an unwanted movement of the transport element can be effectively suppressed. Furthermore, malfunctions can be largely precluded since the drive device is in principle—that is also on reception of a drive signal—not able to drive the transport element due to the interrupted electrical supply.

The user interface can be any desired wired or wireless interface to connect the drive unit e.g. to a control associated with it or even to a control of a unit comprising a plurality of machines or drive units. The operation of the drive unit can therefore run in an automated manner in accordance with an operating routine programmed by a user through this control.

The base control device can in particular be a controllable amplifier for the drive device. The base control device can furthermore be integrated in the drive device. The base control device can, however, also be formed separately from the drive device, with an amplifier for the drive device being able to be integrated therein.

Advantageous embodiments can be seen from the claims, from the description, and from the drawings.

In accordance with an embodiment, the base control device is furthermore adapted to determine the cycle time duration on the basis of a plurality of received control signals, in particular received directly after one another in time. The drive unit is thus able to self teach the cycle time duration (“teach in”). This can be determined, for example, as a maximum, minimum, or averaged duration between any control signals. In addition, however, the respective content of the control signals can also be evaluated and used for determining the cycle time duration. In this manner, the cycle time duration can, for example, be determined to the extent that only those control signals are used that have a corresponding drive signal for the drive device as the content.

Alternatively or additionally to the determination of the cycle time duration on the basis of received control signals, the cycle time duration can be determined from on the basis of positions of the transport element. The base control device can here be adapted to determine the cycle time duration on the basis of a plurality of detected positions of the transport element, in particular detected directly after one another in time. The positions of the transport element do not necessarily have to be determined by means of an associated sensor or detector, but can rather also be determined from any status information of the drive device or of a motor of the drive device (e.g. angular position of a shaft of the motor).

The determination of the cycle time duration can also take place on the basis of a plurality of individual values for the cycle time duration, e.g. by averaging the individual values.

In accordance with a further embodiment, the base control device is operable in a permanent operating mode in which the base control device operates the drive device in full operation mode independently of the cycle time duration. The permanent operation mode can e.g. be activated during the time required for the teaching of the cycle time duration. The permanent operating mode can be set via the user interface or via a separate interface, e.g. a switch.

The drive unit can furthermore be adapted to different operating routines that are each characterized by different cycle time durations. The base control device can thus automatically recognize a deviation from a previous operating routine and can switch into the permanent operating mode to determine the cycle time duration again.

If the cylinder time duration has been successfully determined, the base control device can again switch to the regular full operation mode from where a switch is made in accordance with the invention into the standby operation mode.

The cycle time duration can be settable by the user interface (e.g. via an operator interface) or via a separate interface. Any errors in the determination of the cycle time duration that may only unforeseeably appear in a specific operating scenario can e.g. hereby be manually eliminated.

In accordance with a further embodiment, the drive unit has an output interface that is adapted to output a status signal of the drive device, wherein the status signal comprises information on whether the drive device is in the full operation mode or in the standby operation mode. The status signal can in particular be taken into consideration by a higher level control communicating with the drive unit, e.g. with respect to a latency between a transmitted control signal and the actually carried out movement of the transport element.

In accordance with a preferred embodiment, the base control device is adapted in the standby operation mode to switch the drive device from the standby operation mode into the full operation mode in response to the reception of a control signal. The base control device therefore does not have to receive a separate “wake-up” command to switch the drive device into the full operation mode. Instead, the reception of any desired control signal or of a control signal intended for the drive device is sufficient to automatically switch the drive device into the full operation mode. It thus becomes clear that the drive unit can fully autonomously take care of the change between full operation mode and standby operation mode. The drive unit can consequently independently change in an efficient manner to and fro between the full operation mode and the standby operation mode in an manner adapted to the operating routine—also in the case of interruptions of the operating routine—i.e. independently of separate switchover commands of the higher level control. Such switchover commands can, however, naturally additionally be provided and taken into account as required.

In accordance with a further embodiment, the drive groove of the cam barrel has at least one latching path, with the drive device being able to comprise an electric asynchronous motor. The latching path has the advantage that the position of the transport element is also maintained when the electrical supply of the drive device is interrupted. Freely programmable variants are, however, also conceivable, in particular with a direct drive of the cam barrel, (i.e. the drive groove does not have a latching path, but rather, for example, a constant pitch) that maintain a respective position of the transport element on a interrupted supply of the drive device by e.g. braking means or movement inhibiting means. The drive device can here also comprise an electric synchronous motor.

The object of the invention is also satisfied by a method of operating a drive unit having a transport element, in particular a turntable that has at least one entrainer engaging into a drive groove of a barrel cam, and having an electrical drive device. At least one control signal for the drive unit is received. A drive signal is output to the drive device in dependence on the control signal. In response to the drive signal, the drive device drives the barrel cam to make a rotational movement and thus drives the transport element. The drive device is selectively operated in a full operation mode or, if no control signal is received after the output of a drive signal and after the elapse of a cycle time duration of the drive unit, it is set into a standby operation mode in which an electrical supply of the drive device is interrupted.

The cycle time duration can be determined on the basis of a plurality of received control signals, in particular received directly after one another, and/or on the basis of a plurality of detected positions of the transport element, in particular detected directly after one another in time. The cycle time duration can, for example, be determined on the basis of the time duration between a plurality of control signals received after one another. A mean value or a maximum value of the measured, e.g. ten, time durations can thus be defined as the cycle time duration. Drive information included in the control signals can also be made use of. It is conceivable to take account of a respective duration for a drive procedure of the transport element on the determination of the cycle time duration. Positions of the transport element can be measured or detected for this purpose, with here a mean value formation or a maximum value formation also being conceivable between a plurality of consecutive movement procedures (position changes) of the transport element. It is understood that methods can be used for the determination of the cycle time duration that are familiar to the skilled person and that are statistically motivated for a reliable determination of time patterns such as the distance from outliers that deviate unusually greatly from a mean value.

In accordance with a preferred embodiment, the cycle time duration comprises a safety allowance to compensate uncertainties in the determination of the cycle time duration or to prevent too premature a switchover of the drive device into the standby operation mode. The safety allowance can amount to one to ten percent, preferably five percent, of the determined cycle time duration.

The cycle time duration can as an example comprise a drive time, a standstill time, and a safety allowance. The drive time is the time duration that is required after the output of a drive signal to the drive device for the movement (i.e. starting, continued traveling, and braking) of the transport position between a starting position and a destination position. The drive time can purely by example amount to one second.

The standstill time is the time duration that is provided for the external machining of an object positioned on the transport element. The standstill time can purely by way of example amount to 1.5 seconds. The sum of the drive time and the standstill time accordingly amounts to 2.5 seconds. The safety allowance can amount to 5% of this time duration, that is 0.125 seconds. A cycle time duration of a total of 2.625 seconds therefore results. In accordance with the invention, a switchover into the standby operation mode is made after the output of the drive signal and after the elapse of the cycle time duration. This does not take place if a further control signal is received before the elapse of the cycle time duration in accordance with the cyclic operating routine.

In accordance with a further embodiment, the cycle time duration is determined again in regular or irregular time intervals. The circumstance is hereby taken into account that the cycle time duration can by all means vary. The drive unit can, however, adapt accordingly. It is, however, also conceivable that the cycle time duration is constant. In the latter case, a one-time determination of the cycle time duration is sufficient and the regular or irregular new determination can be dispensed with for reasons of efficiency. The cycle time duration can also be set by a user, in which case an automatic determination of the cycle time duration can be fully dispensed with.

In accordance with a further embodiment, a status signal of the drive device is output that includes a piece of information on whether the drive device is in the full operation mode or in the standby operation mode. The drive device can furthermore be switched over from the standby operation mode into the full operation mode in response to the reception of a control signal.

The invention will be explained only by way of example in the following with reference to the enclosed drawing.

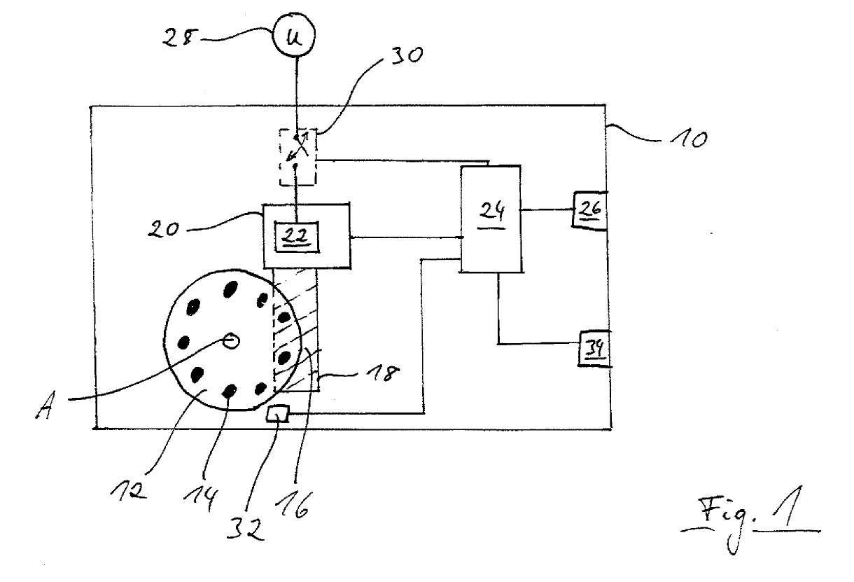

FIG. 1 shows a schematic representation of a drive unit in accordance with the invention.

A drive unit 10—here specifically a rotary indexing table—comprises a transport element that is configured as a turntable 12 and that is rotatable about an axis A extending perpendicular to the plane of the drawing. The turntable 12 has a plurality of entrainers 14 that are distributed in the peripheral direction and that engage into a drive groove of a cam barrel 18 rotatable perpendicular to the axis A in dependence on the rotational position of the turntable 12.

The drive unit 10 further comprises an electrical drive device 20 having an electric motor 22 that is mechanically coupled to the barrel cam 18. The drive device 20 is electrically connected to a base control device 24.

The base control device 24 is adapted to receive control signals for the operation of the drive unit 10 from a user interface 26 programmable by an operator and to output a drive signal to the drive device 20 or to apply current to it as required in dependence on a received control signal.

The drive device 20 is adapted to drive the barrel cam 18 to make a rotational movement and thus to drive the turntable 12 in response to the drive signal.

An electrical supply source 28 that is electrically connected to the electric motor 22 in dependence on the switch position of a switching device 30 is provided for the operation of the electric motor 22. The switch position of the switching device 30 is controlled by the base control device 24.

The base control device 24 is adapted selectively to operate the drive device 20 in a full operation mode in which the switch of the switching device 30 is closed or, if no control signal is received after the output of a drive signal and after the elapse of a cycle time duration 10, to set it into a standby operation mode in which the switch of the switching device 30 is open and thus the electrical supply of the electric motor 22 of the drive device 20 is interrupted. The respective current operating mode can be read via the user interface 26 and/or via a separate output interface 34.

The cycle time duration can be determined by the base control device 24 on the basis of a plurality of received control signals, in particular received via the user interface 26 after one another in time and/or on the basis of a plurality of detected positions of the turntable 12, in particular detected directly after one another in time by means of a position sensor 32. The base control device 24 can for this purpose have computing means, not shown, having a time measurement module and can have a memory for storing the determined cycle time duration. The base control device 24 can generally be a controllable amplifier.

### REFERENCE NUMERAL LIST

10 drive unit

12 turntable

14 entrainer

16 drive groove

18 barrel cam

20 drive device

22 electric motor

24 base control device ≈user interface

28 supply source

30 switching device

32 position sensor

34 output interface

A axis

1.-13. (canceled)

14. A drive unit having a transport element, in particular a turntable, that has at least one entrainer engaging into a drive groove of a barrel cam, having an electrical drive device, and having a base control device, wherein the base control device is adapted to receive control signals for the operation of the drive unit from a user interface programmable by an operator and to output a drive signal to the drive device in dependence on a received control signal; wherein the drive device is adapted to drive the barrel cam to make a rotational movement and thus to drive the transport element in response to the drive signal; and
wherein the base control device is further adapted to selectively operate the drive device in a full operation mode or, if no control signal is received after the output of a drive signal and after the elapse of a cycle time duration of the drive unit, to set it into a standby operation mode in which an electrical supply of the drive device is interrupted.

15. A drive unit in accordance with claim 14, wherein the base control device is further adapted to determine the cycle time duration on the basis of a plurality of received control signals, in particular received directly after one another in time.

16. A drive unit in accordance with claim 15, wherein, the base control device is further adapted to determine the cycle time duration on the basis of a plurality of detected positions of the transport element, in particular detected directly after one another in time.

17. A drive unit in accordance with claim 14, wherein, the base control device is further adapted to determine the cycle time duration on the basis of a plurality of detected positions of the transport element, in particular detected directly after one another in time.

18. A drive unit in accordance with claim 14, wherein the base control device is operable in a permanent operation mode in which the base control device operates the drive device in the full operation mode independently of the cycle time duration.

19. A drive unit in accordance with claim 14, wherein the cycle time duration is settable by the user interface.

20. A drive unit in accordance with claim 14, wherein the drive unit has an output interface that is adapted to output a status signal of the drive device with the status signal comprising information on whether the drive device is in the full operation mode or in the standby operation mode.

21. A drive unit in accordance with claim 14, wherein the base control device is adapted to switch the drive device in the standby operation mode in response to the reception of a control signal from the standby operation mode into the full operation mode.

22. A drive unit in accordance with claim 14, wherein the drive groove of the barrel cam has at least one latching path; and in that the drive device comprises an electric asynchronous motor.

23. A method of operating a drive unit having a transport element, in particular a turntable, that has at least one entrainer engaging into a drive groove of a barrel cam and having an electrical drive device,
wherein at least one control signal for the drive unit is received and a drive signal is output to the drive device in dependence on the control signal;
wherein the drive device drives the barrel cam to make a rotational movement and thus drives the transport element in response to the drive signal; and
wherein the drive device is selectively operated in a full operation mode or, if no control signal is received after the output of a drive signal and after the elapse of a cycle time duration of the drive unit, the drive device is set into a standby operation mode in which an electrical supply of the drive device is interrupted.

24. A method in accordance with claim 23, wherein the cycle time duration is determined on the basis of a plurality of received control signals, in particular received directly after one another, and/or on the basis of a plurality of detected positions of the transport element, in particular detected directly after one another in time.

25. A method in accordance with claim 24, wherein the cycle time duration comprises a safety allowance, in particular with the safety tolerance amounting to one to ten percent, preferably five percent, of the cycle time duration.

26. A method in accordance with claim 23, wherein the cycle time duration comprises a safety allowance, in particular with the safety tolerance amounting to one to ten percent, preferably five percent, of the cycle time duration.

27. A method in accordance with claim 23, wherein the cycle time duration is determined again at regular or irregular time intervals.

28. A method in accordance with claim 23, wherein the drive device is switched over from the standby operation mode into the full operation mode in response to the reception of a control signal.
